(19) United States
(12) Patent Application Publication
(10) Pub. No.: US 2005/0151420 A1
(43) Pub. Date: Jul. 14, 2005

(54) Hybrid electric vehicle powertrain with regenerative braking

(76) Inventors: Dale Crombez, Livonia, MI (US); Patrick Curran, Northville, MI (US); Steven Napier, Canton, MI (US)

Correspondence Address: BROOKS KUSHMAN P.C./FGTL, 1000 TOWN CENTER, 22ND FLOOR, SOUTHFIELD, MI, 48075-1238, US

(21) Appl. No.: 11/050,183

(22) Filed: Feb. 3, 2005

Related U.S. Application Data
(63) Continuation-in-part of application No. 09/850,354, filed on May 7, 2001, now abandoned.

(51) Int. Cl. B60K 1/00

(52) U.S. Cl. 303/152

(57) ABSTRACT

A powertrain control method and strategy for a hybrid electric vehicle is disclosed including establishing electric motor-generator regenerative braking on a first driving axle and engine compression braking for a second driving axle when the vehicle is in a deceleration mode and friction braking the first driving axle when regenerative braking, the friction braking complementing regenerative braking to satisfy a given total braking request.

### CROSS-REFERENCE TO RELATED APPLICATIONS

This application is a continuation-in-part of U.S. application Ser. No. 09/850,354 filed May 7, 2001, entitled “Regenerative Brake System Architecture for an Electric or Hybrid Electric Vehicle.”

### BACKGROUND OF THE INVENTION

1. Field of the Invention

The invention relates to hybrid electric vehicles and to a method for controlling regenerative braking.

2. Background Art

The need to reduce fossil fuel consumption and to improve engine exhaust gas emission quality for vehicles powered predominantly by an internal combustion engine is well known. This need is addressed by using a hybrid electric vehicle powertrain in which an internal combustion engine and an electric motor-generator establish a mechanical power flow path and an electrical power flow path to vehicle traction wheels. The powertrain may include a motor, a generator and a battery that are electrically coupled to define a motor-generator subsystem wherein the subsystem is capable of establishing a braking torque and to capture vehicle kinetic energy during braking, thus charging the battery as a motor acts as a generator. The generator, using battery power, can propel the vehicle in a so-called electromechanical driving mode as the generator acts as a motor. A vehicle system controller coordinates control of the two power sources.

Under normal powertrain operating conditions, the vehicle system controller interprets a driver command for acceleration or deceleration and then determines when and how much torque each power source needs to provide in order to meet the driver's command and to achieve a specified vehicle performance. As in the case of conventional vehicle powertrains, it is possible to achieve better fuel economy and exhaust gas emission quality by operating the engine at or near the most efficient operating region of its engine speed and torque relationship.

It is known design practice to provide such hybrid electric vehicle powertrains with electric regenerative braking. Kinetic energy that the hybrid electric vehicle dissipates during braking, or any other period in which the driver relaxes the accelerator pedal position while the vehicle is in motion, is regenerated as the electric motor operates as a generator. The kinetic energy recovery during this process can be used to recharge the battery and store it for future use.

Typically, regenerative braking is used to control deceleration of a vehicle with a combination of friction braking and regenerative braking. It is known design practice to supplement regenerative braking strategy with conventional friction brake strategy. Friction brakes, for this purpose, are used on all four wheels of the vehicle. Examples of hybrid powertrains embodying these features are U.S. Pat. Nos. 3,774,095; 5,472,264; 5,492,192; 5,683,322; 5,707,115; 5,853,229; and 5,890,982.

### SUMMARY OF THE INVENTION

The invention comprises a powertrain with a first driving axle driven by an electric motor, which also functions as a generator to provide regenerative braking. A second driving axle of the present invention can be powered solely by an internal combustion engine, or, alternatively, powered by an internal combustion engine and a second motor combination. The configuration of the vehicle of the present invention allows for optimization of regenerative braking. On a tip-out of the accelerator by the driver, the electric motor provides a so-called compression regenerative braking on one driving axle to slow the vehicle, while at the same time sending energy to the battery. If the vehicle driver commands a friction braking mode, the electric motor establishes a service regenerative braking operation, up to a regenerative braking limit. Additional braking required to slow or stop the vehicle then is provided by friction braking on the second driving axle. If the second driving axle is powered by an internal combustion engine or by a combination of the internal combustion engine and a second electric motor, compression braking by the internal combustion engine can additionally take place at the second driving axle. There is no friction braking at the first driving axle.

The invention is characterized further by a reduction in vehicle brake system complexity and weight. It can be applied to powertrains regardless of whether the first or second driving axle is at the front of the vehicle or at the rear of the vehicle. In any case, only one of the driving axles requires conventional friction brakes.

The invention further is characterized by a strategy that comprises a first hierarchy of method steps when the vehicle driver initiates a throttle tip-out to initiate deceleration. A second, separate hierarchy of method steps is used in the braking strategy if the operator initiates a service braking request.

During a so-called throttle tip-out event, a vehicle system controller will calculate the engine compression braking request. The strategy will then determine whether the battery state-of-charge has a sufficient so-called headroom or energy (charge) storage capacity available. If sufficient charge capacity is available, a compression regenerative braking routine is initiated. If the battery charge is not sufficient, the braking is achieved by engine compression braking.

If the driver applies the brakes at the beginning of the deceleration mode, a so-called service braking request is calculated. The strategy then will determine whether the battery state-of-charge headroom is sufficient to accommodate braking kinetic energy storage in the battery. If the head room is sufficient, a so-called service regenerative braking routine is initiated. If the battery state-of-charge head room is not sufficient for this purpose, the friction brakes are used to decelerate the vehicle.

If the driver desires to bring the vehicle to a complete stop following compression braking, the friction brakes will be available for that purpose regardless of which strategy hierarchy is used.

### BRIEF DESCRIPTION OF THE DRAWINGS

FIG. 1 is a schematic drawing of an overall hybrid electric vehicle powertrain capable of embodying the invention;

FIGS. 2a and 2b show software strategy flow diagrams for, respectively, regenerative braking when the friction brakes are not applied and regenerative braking when the friction brakes are applied;

FIG. 3 is a schematic representation of a hybrid electric vehicle powertrain with an internal combustion engine for one driving axle, and a motor-generator and battery subsystem for a second driving axle, together with friction brakes for the engine powered driving axle; and

FIG. 4 is a schematic representation of a hybrid electric vehicle powertrain incorporating features of the powertrain of FIG. 3 and wherein the engine acts in cooperation with a second motor-generator and a planetary gear unit, together with friction brakes.

### DETAILED DESCRIPTION OF EMBODIMENTS OF THE INVENTION

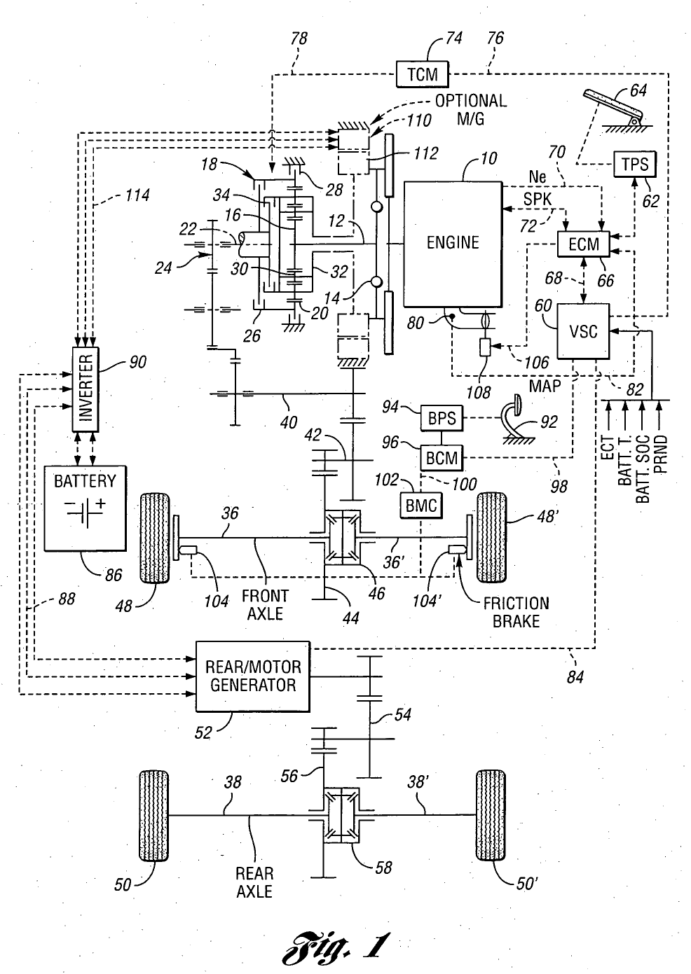

In FIG. 1, numeral 10 designates an internal combustion engine with a crankshaft and a flywheel connected to a torque input shaft 12 through a damper assembly 14. The shaft 12 is connected to sun gear 16 of a planetary gear unit 18. Ring gear 20 of the planetary gear unit 18 is connected to shaft 22 of torque transfer gearing 24. That connection is established by selectively engageable friction clutch 26. Ring gear 20 can be braked by selectively engageable friction brake 28.

Compound planetary gearing establishes a driving connection between sun gear 16 and ring gear 20. A compound planetary carrier 32 rotatably supports the compound pinions. The carrier can be connected selectively to shaft 22 by friction clutch 34.

FIG. 1 shows front driving axles at 36 and 36′ and rear driving axles at 38 and 38′. The torque transfer gearing 24 distributes torque from shaft 22 to countershaft gear subassembly 40, which drives a second countershaft gear assembly 42 to establish a torque delivery path to final drive gear 44. Differential gear assembly 46 is driveably connected to front drive axle 36, as well as to a companion drive axle 36′. Axles 36 and 36′, as well as axles 38 and 38′, typically are referred to as axle half shafts. The axles power front traction wheels 48 and 48′ and rear traction wheels 50 and 50′.

A rear motor-generator 52 has an armature driveably connected through torque transfer gearing 54 to gear 56, which is connected to the differential pinion carrier for differential 58. One side gear of the differential 58 is connected to axle half shaft 38′ and the other side gear is connected to axle half shaft 38.

The planetary gearing 18 is capable of providing two forward driving ratios as engine torque is distributed to the front axle half shafts 36 and 36′. A low speed ratio is effected by applying friction clutch 34 as brake 28 is applied. Ring gear 20, at this time, acts as a reaction element and driving torque is distributed through the compound planetary carrier through the engaged clutch 34 to shaft 22.

To achieve a ratio change to a high speed ratio, clutch 34 remains applied and clutch 26 is applied, while brake 28 is released. A direct mechanical torque flow path is established between the engine crankshaft and shaft 22 for each speed ratio when the engine is commanded to provide engine compression braking, as will be explained subsequently.

The powertrain system schematically illustrated in FIG. 1 is under the control of a vehicle's system controller 60, which receives operating variable inputs, including an engine coolant temperature signal (ECT), a battery temperature signal (BATT.T), a battery state-of-charge signal (BATT.SOC) and a driver selected powertrain drive range signal for park, reverse, neutral or drive (PRND). A throttle position sensor 62 (TPS) establishes a position signal for powertrain throttle pedal 64. That throttle position signal is transmitted to an engine control module 66 (ECM), which is in communication with the vehicle system controller 60 (RSC), as shown at 68. The engine control module 66 receives an engine speed signal from the engine 10, as shown at 70 (Nₑ). It also develops a spark retard signal for the engine, as shown at 72.

The transmission gearing 18 is under the control of a transmission control module 74 (TCM), which receives control instructions from the vehicle system controller 60 over signal flow path 76. The transmission control module controls engagement and release of the friction clutches and the brake for the gearing 18 by issuing engagement and release signals through signal flow path 78, which are received by a transmission control valve body (not shown).

An absolute manifold pressure signal (MAP) is developed at the engine intake manifold 80. The signal is distributed to the engine control module 66 over signal flow path 82.

The vehicle system controller 60 is in communication with the rear motor-generator 52 over signal flow path 84. The rear motor-generator 52 is powered by battery 86, the voltage distribution path between the battery and the motor-generator being indicated schematically at 88. Preferably, the motor-generator 52 is a high voltage induction motor. The two-phase power supply from battery 86 is distributed to inverter 90, which establishes a three-phase electric power supply for the induction motor at 52.

The powertrain system includes a driver operated brake pedal 92 and a brake pedal position sensor 94 (BPS), which develops a signal functionally related in magnitude to pedal depression. The signal developed at the brake pedal position sensor is distributed to a brake control module 96 (BCM), which in turn communicates, as shown at 98, with the vehicle system controller 60. The brake control module issues a control signal through signal flow path 100 to a brake master cylinder (BMC), as shown at 102. The brake master cylinder 102 distributes brake pressure through brake pressure lines 104 to friction wheel brake actuators 104 and 104′ for traction wheels 48 and 48′, respectively.

The engine control module 66 distributes a throttle position signal, as shown at 106, to a throttle controller 108 for the engine throttle.

The powertrain system illustrated in FIG. 1 may include an optional motor-generator 110 with a rotor 112 connected driveably to the compound planetary carrier of gearing 18. The optional motor-generator 110 may be powered by battery 86, which may be common to the motor-generator 52, the inverter 90 again functioning, as shown at 114, as a part of a three-phase power distribution path, the motor-generator 110 preferably being an induction motor-generator as is the case for rear motor-generator 52.

The configuration of the powertrain system of the invention allows for optimization of the regenerative braking such that on a tip-out of the accelerator, the electric motor-generators provide regenerative braking on their respective driving axle to slow the vehicle while at the same time sending electrical energy to the battery. If the vehicle operator commands a braking operation by depressing the brake pedal, the electric motor-generators continue to provide braking, which hereinafter may be referred to as service braking, to their respective driving axle up to a regenerative limit. Any additional braking required to slow the vehicle or to stop the vehicle then can be provided by the friction braking on the second driving axle. If the second driving axle is powered by an internal combustion engine or by an internal combustion engine and second motor combination, compression braking by the internal combustion engine can additionally occur at the second driving axle. A feature of the present invention is that there are no friction service brakes at the rear driving axles.

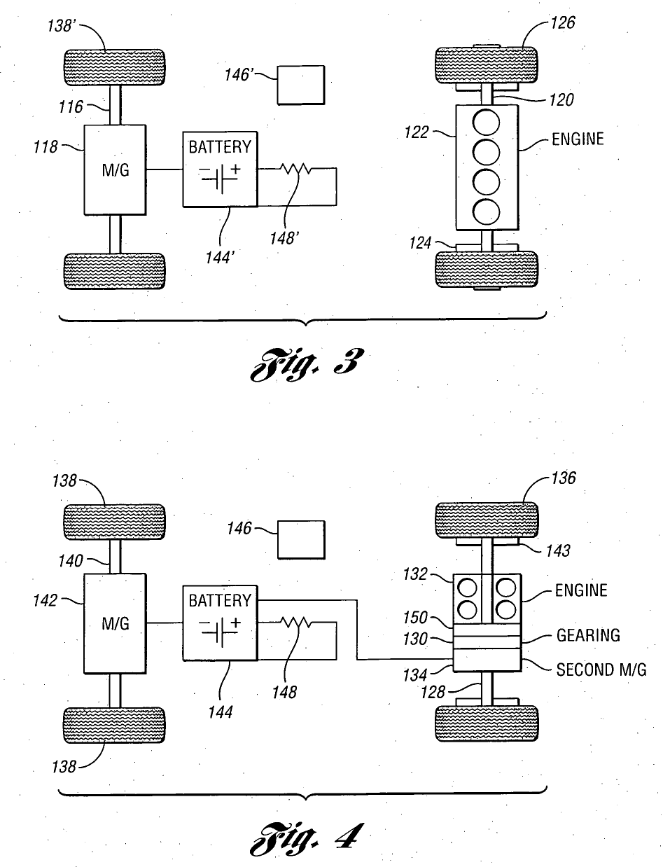

In the schematic powertrain illustration of FIG. 3, a hybrid electric vehicle has a first driving axle 116 and a motor-generator 118. A second driving axle 120 is powered by an internal combustion engine 122. The internal combustion engine 122 may be a transversely mounted engine or it may be aligned with the major axis of the vehicle. The engine 122 typically will be torsionally connected to the second axle 120 by way of a differential gear set (not shown). This is conventional in the prior art.

The second axle of the arrangement of FIG. 3 has hydraulically powered or, optionally, electrically powered friction brakes, as shown at 124 for each of two traction wheels 126.

FIG. 4 illustrates still another arrangement of the powertrain components. In the case of the powertrain of FIG. 4, the second driving axle, shown at 128, has a parallel-series hybrid electric vehicle divided power configuration.

A planetary gear set 130 divides the output energy of engine 132 into a series path from the engine to a second motor-generator 134 and a parallel path from the engine to the traction wheels, shown at 136. The speed of the engine can be controlled by varying the split or power ratio for the series path while maintaining a mechanical driving connection through the parallel path. A powertrain arrangement having these characteristics may be seen by referring to U.S. patent application Ser. No. 10/709,537, filed May 12, 2004, entitled “Method for Controlling Starting of an Engine in a Hybrid Electric Vehicle Powertrain.”

In the configuration of FIG. 4, the traction wheels 138 are driven through driving axle half shafts, as shown at 140, by a motor-generator 142. The motor-generator 142 also can brake the axle half shafts 140 by electric regenerative braking. The motor-generator 142 is electrically coupled to battery 144. A corresponding battery for the FIG. 3 configuration is shown at 144′.

When the accelerator pedal is relaxed by the vehicle operator, regenerative braking is performed by the motor-generator 142 on axle 140. The regenerative braking will occur up to a first level for axle 140. If the operator desires a greater level of braking, the hydraulically or electrically actuated friction brakes 143 at the second driving axle 128 will provide supplemental braking torque. A controller 146, corresponding to the previously described vehicle system controller 60, will continuously monitor the regenerative braking headroom available. A corresponding controller for the FIG. 3 configuration is shown at 146′. If battery 144 is charged beyond a predefined level, there will be no regenerative braking headroom. If the regenerative braking headroom is not available, controller 80 will signal the battery to dissipate power through a thermal load resistor 148 to ensure that regenerative braking is at all times available. A corresponding thermal load resistor is shown in FIG. 3 at 148′ for battery 144′.

In the case of the configuration of FIG. 3, regenerative braking will be provided by motor-generator 118 when the vehicle operator's foot is lifted off the accelerator. Additionally, compression braking will occur with the internal combustion engine 122. If the regenerative braking by the motor and the compression braking by the internal combustion engine 122 are not sufficient, additional braking will be available by actuating the friction brakes 124.

In the case of FIG. 4, regenerative braking headroom for the motor-generator 142 will be monitored, as previously described. The battery 144 can be recharged not only by the regenerative braking of the motor 142, but also by the internal combustion engine as it powers the generator 34.

When the vehicle driver's foot is lifted off the accelerator, motor-generator 142 as well as the engine 132 may provide regenerative braking. The internal combustion engine 132, in the configuration of FIG. 4, compressive brakes up to and above a braking level defined by the vehicle system controller. This brakes driving axle 140 since second motor-generator 134 can be activated against the internal combustion engine 132 compressive braking, thereby increasing headroom in battery 144 and increasing the effectiveness of the regenerative braking of motor-generator 142.

When compression braking by the engine is not desired, regenerative braking of the motor-generator 142 can provide all of the regenerative braking exclusive of the engine. This can be accomplished by disengaging the engine from the driving axle 128 by a disconnect clutch schematically shown at 150 in FIG. 4. In the case of the configuration of FIG. 1, the engine can be removed from the regenerative torque delivery path by releasing brake 28 with one or both of the clutches 18 and 34 disengaged. Under those conditions, the engine will idle. The same is true for the configuration of FIG. 4 when clutch 150 is disengaged.

In the configuration of FIG. 1, the engine may be disconnected from the torque flow path to the shaft 22 also by a neutral clutch between the engine crankshaft and torque delivery shaft 12, although a neutral clutch is not illustrated in FIG. 1.

If the optional motor-generator 110 is included in the configuration of FIG. 1, regenerative braking by the optional motor-generator 110 will complement the regenerative braking of rear motor-generator 52.

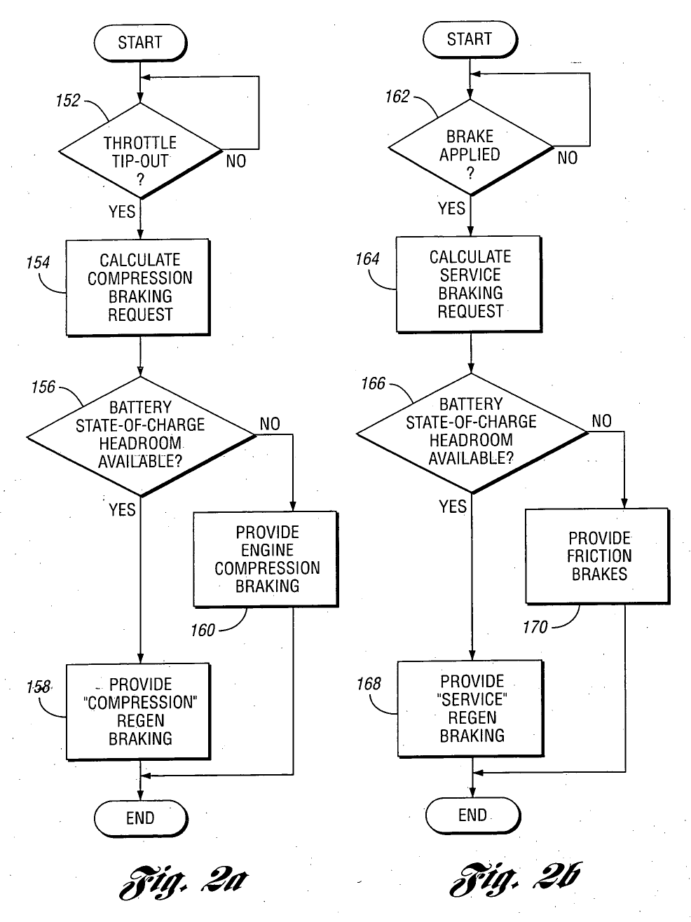

The coordination of the regenerative braking of the vehicles is determined by the vehicle system controller 60 in response to the various operating variables as previously described. The compression braking of the engine and the regenerative braking of the motor-generators occurs according to a hierarchal strategy, which will be explained with reference to FIGS. 2a and 2b.

FIGS. 2a and 2b illustrate separate control routines for throttle tip-out and driver actuated brake peal braking. The routine that would be relied upon by the vehicle system controller would depend upon whether the friction brakes are being applied by the operator. If the vehicle brakes are not applied, the vehicle system controller will determine at decision block 152 whether the vehicle operator has initiated a throttle tip-out. If a throttle tip-out has not occurred, execution of the strategy will not begin. If a throttle tip-out has occurred, the controller will calculate at action block 154 a total compression braking request, which is determined by the current driving conditions and the powertrain operating variables. Having determined the total compression braking requirements, a decision is made at decision block 156 whether the battery state-of-charge headroom is sufficient to accommodate the requested compression braking. If sufficient headroom is available, the routine will provide a so-called compression regenerative braking mode at 158 wherein the rear motor-generator 52 is commanded by the vehicle system controller to provide motor-generator regenerative braking. If the battery state-of-charge is low and headroom is not available, as determined at decision block 156, either the clutch 26 or the clutch 34, or both, establishes a mechanical torque flow path from the engine crankshaft to the input shaft 22 for the torque transfer gearing 24. The selection of which clutch to apply is determined by the vehicle system controller, which distributes an appropriate signal to the transmission control module 74 to engage an appropriate clutch. In the alternative, both clutches can be applied if a direct driving connection between the crankshaft and the shaft 22 is desired.

In the case of a design schematically illustrated in FIG. 4, the clutch 150 is disengaged if engine compression braking is not desired and regenerative compression braking by the motor 142 is desired.

The term “compression regenerative braking” is used in this description since the effect of the regenerative braking is comparable to the actual mechanical engine compression braking that would be provided by the engine when the engine is in the torque flow path.

Engine compression braking occurs at action block 160 if the decision at decision block 156 is negative. The regenerative braking step at action block 158 then is bypassed.

If regenerative braking is initiated when the friction brakes are applied, as determined at decision block 162, the vehicle system controller will calculate a so-called service braking request at action block 164. If the brakes are not applied, the routine will return to the starting point as the previous controller routine is initiated.

If the decision at decision block 162 is positive and a service braking request is determined at 164, the routine then will determine at decision block 166 whether the battery state-of-charge headroom is sufficient to accommodate the braking request. If there is sufficient headroom, the routine will proceed to action block 168, which initiates the service regenerative braking function as the rear motor-generator 52, in the case of FIG. 1 is activated, or as motor-generator 118 or motor-generator 142, in the case of FIGS. 3 and 4, respectively, is activated. If there is not sufficient battery state-of-charge headroom available, the friction brakes apply the necessary braking, as indicated at action block 170.

The term “service regenerative braking” is used in this description to describe regenerative braking when the driver requests braking by depressing the brake pedal when the vehicle system controller commands regenerative torque and the battery state-of-charge headroom is sufficient to accommodate the total braking request. The braking function then is analogous to braking using friction brakes even though the friction brakes (service brakes) are not applied.

In each of the configurations, there are no friction service brakes on the non-powered wheels. This feature reduces vehicle complexity and weight. The friction service brakes are appropriately sized so that desired stopping distance can be maintained when regenerative braking is disabled.

Although the embodiments of the invention have been described, it will be apparent to persons skilled in the art that modifications may be made without departing from the scope of the invention. All such modifications and equivalents thereof are intended to be covered by the following claims.

1. A method for braking a vehicle powertrain having a first driving axle exclusively driven electrically, the first driving axle exclusively having only electric regenerative brakes, the vehicle having also a second driving axle driven by an internal combustion engine, the second driving axle exclusively having only friction brakes;
the method comprising:
monitoring a headroom of regenerative braking available and dissipating power through a thermal resistor to make more headroom available for regenerative braking;
electrically braking the first driving axle regeneratively up to a first level;
frictionally braking the second driving axle when a braking requirement of the vehicle is greater than the first level; and
additionally compression braking the second driving axle with the internal combustion engine up to the first level and above the first level of braking the vehicle.

2. A method for braking a vehicle with a hybrid electric powertrain having first and second driving axles, an electric power system comprising an electric motor-generator and battery, an internal combustion engine with an engine throttle, a vehicle system controller including an engine throttle control and a motor-generator control, the electric motor-generator being driveably connected to the first driving axle and the internal combustion engine being driveably connected to the second driving axle, the internal combustion engine having a driver-operated engine throttle;
the method comprising the steps of:
determining whether the engine throttle is moved to a throttle tip-out position;
calculating a total compression braking request by the vehicle controller as a function of powertrain operating variables in response to a driver demand for vehicle braking;
monitoring battery state-of-charge;
comparing monitored battery state-of-charge to a predetermined battery state-of-charge to establish a current state-of-charge headroom when the total compression braking request is calculated; and
compression regenerative braking the first driving axle when a current state-of-charge headroom exceeds a predetermined amount whereby the vehicle deceleration with regenerative braking.

3. A method for braking a vehicle with a hybrid electric powertrain having first and second driving axles, an electric power system comprising an electric motor-generator and battery, an internal combustion engine with an engine throttle, a vehicle system controller including an engine throttle control and a motor-generator control, the electric motor-generator being driveably connected to the first driving axle and the internal combustion engine being driveably connected to the second driving axle, the internal combustion engine having a driver-operated engine throttle;
the method comprising the steps of:
determining whether the engine throttle is moved to a throttle tip-out position;
calculating a total compression braking request by the vehicle controller in response to a driver demand for vehicle braking;
monitoring battery state-of-charge;
comparing monitored battery state-of-charge to a predetermined battery state-of-charge to establish a current state-of-charge headroom when the total compression braking request is calculated; and
establishing a mechanical driving connection between the engine and the second driving axle when a current state-of-charge headroom is less than a predetermined amount whereby the vehicle decelerates with engine compression braking.

4. The method set forth in claim 2 wherein the powertrain comprises at least one friction brake on the second driving axle, and a brake control module controlled by the vehicle system controller;
monitoring vehicle speed during deceleration following a total compression braking request; and
applying the friction brake as regenerative braking at the first driving axle is reduced to a determined amount whereby the vehicle may be brought to a stop.

5. The method set forth in claim 3 wherein the powertrain comprises at least one friction brake on the second driving axle, and a brake control module controlled by the vehicle system controller;
monitoring vehicle speed during deceleration following a total compression braking request; and
applying the friction brake as regenerative braking at the first driving axle is reduced to a determined amount whereby the vehicle may be brought to a stop.

6. A method for braking a vehicle with a hybrid electric powertrain having first and second driving axles, an electric motor-generator and battery system and an internal combustion engine with an engine throttle, a vehicle system controller including an engine throttle control and a motor-generator control, the electric motor-generator being driveably connected to the first driving axle and the internal combustion engine being driveably connected to the second driving axle, a friction brake including driver-actuated brake element for initiating a service braking request, a friction brake element connected to the second driving axle for friction braking the vehicle with friction braking torque at only the second axle, the internal combustion engine throttle;
the method comprising the steps of:
determining whether the driver has requested service braking;
calculating a total service braking request when the driver has actuated the brake element;
monitoring battery state-of-charge;
comparing monitored battery state-of-charge to a predetermined battery state-of-charge to establish a current state-of-charge headroom when the total service braking request is calculated; and
providing service regenerative braking of the vehicle when a current state-of-charge headroom exceeds a predetermined amount whereby the vehicle decelerates with regenerative braking.

7. A method for braking a vehicle with a hybrid electric powertrain having first and second driving axles, an electric power system comprising an electric motor-generator and battery, an internal combustion engine with an engine throttle control, a vehicle system controller including an engine throttle control and a motor-generator control, the electric motor-generator being driveably connected to the first driving axle and the internal combustion engine being driveably connected to the second driving axle;
a driver-actuated brake element for initiating a service braking request, a friction brake including a friction brake element connected to the second driving axle for friction braking the vehicle with friction braking torque at only the second axle, the internal combustion engine having a driver-operated engine throttle;
the method comprising the steps of:
determining whether the driver has requested service braking;
calculating a total service braking request where the driver has actuated the brake element;
monitoring battery state-of-charge;
comparing monitored battery state-of-charge to a predetermined battery state-of-charge to establish a current state-of-charge headroom when the total service braking request is calculated; and
applying the friction brake to effect friction service braking of the vehicle when a current state-of-charge headroom does not exceed a predetermined amount whereby the vehicle decelerates with friction braking at the second driving axle.

8. The method set forth in claim 6 including the steps of:
monitoring vehicle speed during deceleration following a total service braking request; and
applying the friction brake as service regenerative braking at the first driving axle is reduced to a predetermined amount whereby the vehicle may be brought to a stop.

9. The method set forth in claim 2 wherein the powertrain includes a second electric motor-generator driveably connected to the second driving axle and the method steps include the step of complementing regenerative braking provided by the electric motor-generator driveably connected to the first driving axle.

10. The method set forth in claim 3 wherein the powertrain includes a second electric motor-generator driveably connected to the second driving axle and the method steps include the step of complementing regenerative braking provided by the electric motor-generator driveably connected to the first driving axle.
